(19) United States
(12) Patent Application Publication
(10) Pub. No.: US 2005/0188323 A1
(43) Pub. Date: Aug. 25, 2005

(54) Template creation apparatus and creation method

(75) Inventor: Akihiro Shibata, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/056,248

(22) Filed: Feb. 14, 2005

(30) Foreign Application Priority Data
Feb. 20, 2004 (JP) 044493/2004

(51) Int. Cl. G06F 17/20

(52) U.S. Cl. 715/760

(57) ABSTRACT

A template creation apparatus includes a text input unit, block information input unit, data model input unit, generation rule input unit, and template generation unit. The text input unit inputs at least one sample text as a sample of the text which can be generated by using the template. The block information input unit inputs, in correspondence with the sample text, block information representing the range and structure of an insertion block in which the character string can be replaced in the template. The data model input unit inputs a data model as the base of the character string of the insertion block in the sample text. The generation rule input unit inputs a generation rule to generate the character string of the insertion block in the sample text from the data model. The template generation unit generates a template by making the range of the insertion block in the sample text replaceable and inserting the character string generated on the basis of the generation rule in the replaceable insertion block. A template creation method and program are also disclosed.

### BACKGROUND OF THE INVENTION

The present invention relates to a template creation apparatus and creation method of creating a template desired by a user.

A template (model) is used to generate a text such as the HTML (HyperText Markup Language) source of a Web page or a program source code. A template contains the general-purpose data structure or algorithm of a text in a form easy to use. When a template is used as a model, a text can easily be generated.

There is a mechanism called a template engine which creates a text desired by a user by using a template. When the template engine is used to generate the HTML source of a Web page, the user can generate the HTML source while being conscious of the display image of an actual content.

A general template engine has a template scripting language. The language has a notation which indicates insertion of a character string generated from a data model to a predetermined position in a form text and a control syntax to develop a repetitive structure or recursive structure in a model into a text. For this reason, the template engine can be used not only to generate a form text having a simple structure but also to generate a file such as a program source with a complex structure. Examples of the template engine are “Velocity” and “JSP (Java Server Pages)”.

In “the apache vacarta project”, [online], Apache Software Foundation, [searched Feb. 13, 2004], Internet <URL:http://jakarta.apache.org/velocity/user-guide.html> (reference 1), an example of the conventional template engine is described. The template engine described in reference 1 is “Velocity”. “Velocity” has VTL (Velocity Template Language) as a template scripting language. VTL has various control syntaxes including a control syntax which describes an operation of inserting, in a fixed text, a result obtained by referring to a data model from a context of VTL and editing or processing the data model and a control syntax which describes an operation of developing a repetitive structure in a data model into a character string. For this reason, VTL can be used to automatically generate the HTML source of a Web page or a more complex program source code.

In “Java Technology Java 2 Platform, Enterprise Edition (J2EE)”, [online], Sun Microsystems, Inc, [searched Feb. 13, 2004], Internet <URL:http://java.sun.com/j2ee/index.jsp> (reference 2), another example of a conventional template engine having the same function as “Velocity” is described. The template engine described in reference 2 is “JSP”. Even with “JSP”, an HTML source can automatically be generated.

Japanese Patent Laid-Open No. 2001-312490 (reference 3) discloses an example of a conventional automatic template generation system. As shown in FIG. 1 of reference 3, the conventional automatic template generation system comprises a sample page storage unit and a template extraction means. The sample page storage unit stores a plurality of sample pages which meet the user's needs.

The template extraction means extracts, as content-matching constituent elements, constituent elements which are laid out at almost the same position in the plurality of sample pages stored in the sample page storage unit and have the same content. The template extraction means also extracts, as different-content constituent elements, constituent elements which are laid out at almost the same position in the plurality of sample pages and have different contents. The template extraction means generates a template in which the extracted content-matching constituent elements are laid out at positions corresponding to the layout positions of the content-matching constituent elements on the sample pages, and the description fields of the different-content constituent elements, which can be input in accordance with the user's need, are laid out at positions corresponding to the layout positions of the different-content constituent elements on the sample pages.

In this way, the conventional automatic template generation system generates a template in which the user can describe desired constituent elements including common parts of a plurality of sample pages as content-matching constituent elements and individual parts as different-content constituent elements. When this template is used, the user can easily create a text in which common parts are automatically generated, and individual parts are described as contents desired by him/her.

Conventionally, a template engine is mainly used to generate a text based on a relatively simple generation rule by, e.g., generating a Web page having a standard pattern from a database. In such an application purpose, the structure of the template is also relatively simple. Hence, it is not so difficult to generate a template.

However, when a program source code is to be generated by using a template engine, the text generation rule is complex. When the text generation rule is complex, the structure of the template to be used for text generation is also complex.

According to the template engine described in reference 1 or 2, a complex program source code can automatically be generated. However, it is difficult to define and review the specifications to be created. In addition, in creating a template, the productivity of debug of the template is low. Furthermore, it is difficult to test the created template.

According to the automatic template generation system described in reference 3, a template to be used to generate a complex program source code can be generated. However, it is not easy to collect a plurality of complex samples having similarity. In addition, it is difficult to specify the specifications of the template to be created.

### SUMMARY OF THE INVENTION

It is an object of the present invention to provide a template creation apparatus and template creation method which simplify definition and review of the specifications of a template.

It is another object of the present invention to provide a template creation apparatus and template creation method which facilitate debug and test of a template.

In order to achieve the above objects, according to the present invention, there is provided a template creation apparatus which creates a template to be used as a model in generating a text containing a character string, comprising text input means for inputting at least one sample text serving as a sample of the text which can be generated by using the template, block information input means for inputting, in correspondence with the sample text input by the text input means, block information representing a range and structure of an insertion block in which a character string can be replaced in the template, data model input means for inputting a data model serving as a base of the character string of the insertion block in the sample text input by the text input means, generation rule input means for inputting a generation rule to generate the character string of the insertion block in the sample text from the data model input by the data model input means, and template generation means for generating the template by making the range of the insertion block in the sample text input by the text input means replaceable and inserting the character string generated on the basis of the generation rule in the replaceable insertion block.

### BRIEF DESCRIPTION OF THE DRAWINGS

FIG. 1 is a block diagram showing the arrangement of a template creation apparatus according to the first embodiment of the present invention;

FIGS. 2A and 2B are flowcharts showing the operation of the template creation apparatus shown in FIG. 1, in which FIG. 2A shows the main routine, and FIG. 2B shows the subroutine;

FIG. 3 is a flowchart showing details of the operation in step A22 shown in FIG. 2B;

FIG. 4 is a flowchart showing details of the operation in step A23 shown in FIG. 2B;

FIG. 5 is a flowchart showing details of the operation in step A24 shown in FIG. 2B;

FIG. 6 is a flowchart showing the main routine of the operation in step A25 shown in FIG. 2B;

FIGS. 7A and 7B are flowcharts showing the subroutine of the operation in step A25 shown in FIG. 2B;

FIG. 8 is a view showing an example of a text input as a case;

FIG. 9 is a view showing an example of a manner to separate block information input as a case;

FIG. 10 is a view showing the structure of a case set used in the template creation apparatus shown in FIG. 1, examples of names given to pieces of information, and their notations;

FIG. 11 is a view showing content examples of the text, block information, data model, and generation rule shown in FIG. 10;

FIG. 12 is a view showing an information set of a case obtained by executing processing shown in FIG. 2B for the text shown in FIG. 8;

FIG. 13 is a view for explaining the outline of processing by the template generation unit shown in FIG. 1;

FIG. 14 is a view showing a detailed example of processing in step A2517 shown in FIG. 7B;

FIG. 15 is a block diagram showing the arrangement of a template creation apparatus according to the second embodiment of the present invention;

FIG. 16 is a flowchart showing the operation of the template creation apparatus according to the second embodiment;

FIG. 17 is a flowchart showing the main routine of the operation in step B1 shown in FIG. 16;

FIGS. 18A and 18B are flowcharts showing the subroutine of the operation in step B1 shown in FIG. 16;

FIG. 19 is a flowchart showing details of the operation in step B2 shown in FIG. 16;

FIG. 20 is a view showing a detailed example of processing in steps B102 and B103 shown in FIG. 18A;

FIG. 21 is a view showing a detailed example of processing shown in FIG. 19;

FIG. 22 is a block diagram showing the arrangement of a template creation apparatus according to the third embodiment of the present invention; and

FIGS. 23A and 23B are flowcharts showing the operation of the template creation apparatus shown in FIG. 22.

### DESCRIPTION OF THE PREFERRED EMBODIMENTS

The present invention will be described below in detail with reference to the accompanying drawings. The template creation apparatus of the present invention includes a computer. The template creation apparatus creates a template suitable for generation of a text on the basis of the text to be generated from the template. To generate a template, at least one text is necessary as a sample.

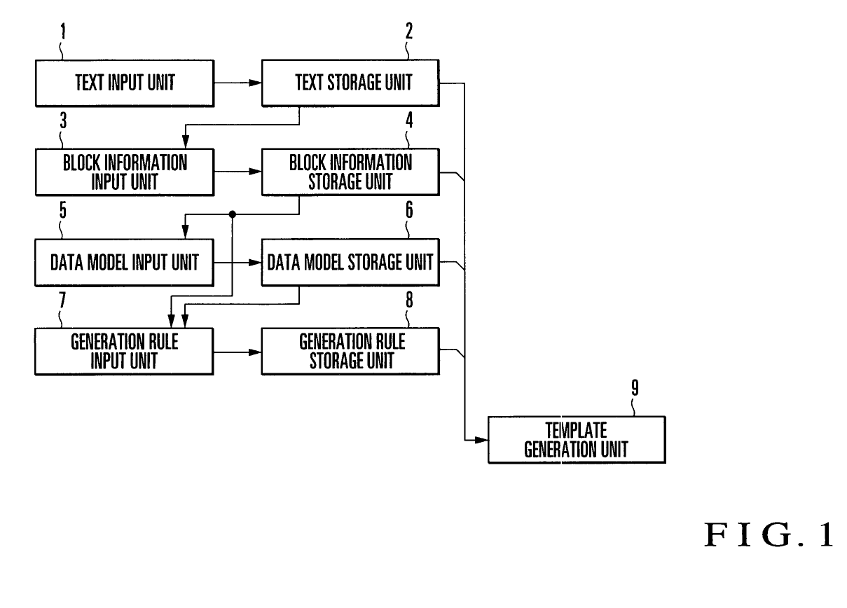

FIG. 1 shows the arrangement of a template creation apparatus according to the first embodiment of the present invention. Referring to FIG. 1, the template creation apparatus according to the first embodiment comprises a text input unit 1, text storage unit 2, block information input unit 3, block information storage unit 4, data model input unit 5, data model storage unit 6, generation rule input unit 7, generation rule storage unit 8, and template generation unit 9.

The text input unit 1 inputs at least one text to be used as a sample of a text which should be generated from a template and sends the text to the text storage unit 2. The text is expressed by a character string. The text storage unit 2 stores at least one text input by the text input unit 1. In association with one template to be created, the text storage unit 2 stores at least one sample text. The text storage unit 2 can also store a plurality of sample texts.

For each of the texts stored in the text storage unit 2, the block information input unit 3 inputs block information which is information explicitly indicating a range where the character string can be replaced by the template engine and a repetitive structure in that range. The block information is sent to the block information storage unit 4. The block information storage unit 4 stores the block information input from the block information input unit 3 together with the correspondence relationship to the text stored in the text storage unit 2.

The data model input unit 5 inputs a data model corresponding to each of the pieces of block information stored in the block information storage unit 4. The data model is sent to the data model storage unit 6. A data model is information corresponding to the contents of each block in accordance with a block structure such as nest structure or repetitive structure. When a certain generation rule is applied to the data model, the character string of the contents of the block can be obtained. The data model storage unit 6 stores the data model input from the data model input unit 5 together with the correspondence relationship to the block information stored in the block information storage unit 4.

The generation rule input unit 7 inputs the generation rule of the character string in each block. The generation rule is sent to the generation rule storage unit 8. A generation rule is a rule to define a method of generating the character string in each block. The generation rule is obtained on the basis of the text stored in the text storage unit 2, the block information stored in the block information storage unit 4 in correspondence with the text, and the data model stored in the data model storage unit 6 in correspondence with the block information. The generation rule is information to define the character string in which block is generated when which manipulation processing is executed for which data model.

The generation rule storage unit 8 stores the generation rule input from the generation rule input unit 7 in correspondence with the block information of the block in which the processing result is to be inserted. The set of the input text, block information, data model, and generation rule forms one case. To generate a template, at least one case must be input. A plurality of cases may be input. The text, block information, data model, and generation rule input as a case form information representing what kind of template should be generated, i.e., the specifications of a template.

The template generation unit 9 generates a template on the basis of the case input in advance, i.e., the text stored in the text storage unit 2, the block information stored in the block information storage unit 4 in association with the text, the data model stored in the data model storage unit 6 in association with the block information, and the generation rule stored in the generation rule storage unit 8 in association with the block information. The template generation unit 9 generates a template by making the range of the insertion block in the text replaceable, and inserting a character string generated by applying the generation rule to the data model in the replaceable insertion block. When element blocks are present in the insertion block, the template generation unit 9 removes the overlap between the element blocks. When an overlap is present in insertion block between texts, the template generation unit 9 removes the overlap between the insertion blocks.

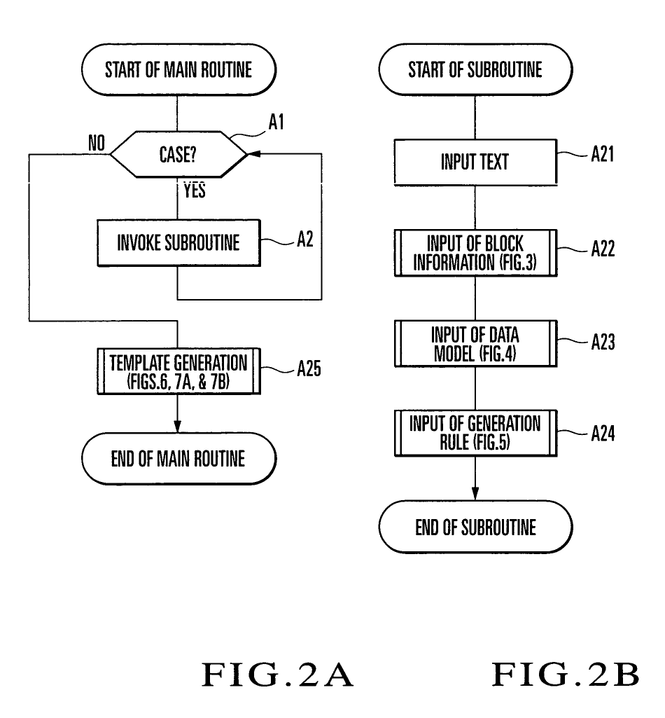

The operation of the template creation apparatus according to the first embodiment will be described next with reference to FIGS. 2A and 2B.

Referring to FIG. 2A, the template creation apparatus determines first whether a case (sample) to be input is present (step A1). It is determined here whether a text to be used as a case is present. The text to be used as a case indicates an example of the text to be generated by using the template to be created. To generate a good template, an appropriate text is preferably selected in advance.

If a case to be input is present, the template creation apparatus invokes the subroutine shown in FIG. 2B. When the processing of the subroutine is ended, the flow returns to the processing in step A1 (step A2). The template creation apparatus inputs at least one case to be input by repeating steps A1 and A2. When all cases to be input are input, it is determined in step A1 that no case to be input is present. Next, the template creation apparatus creates a template (step A25).

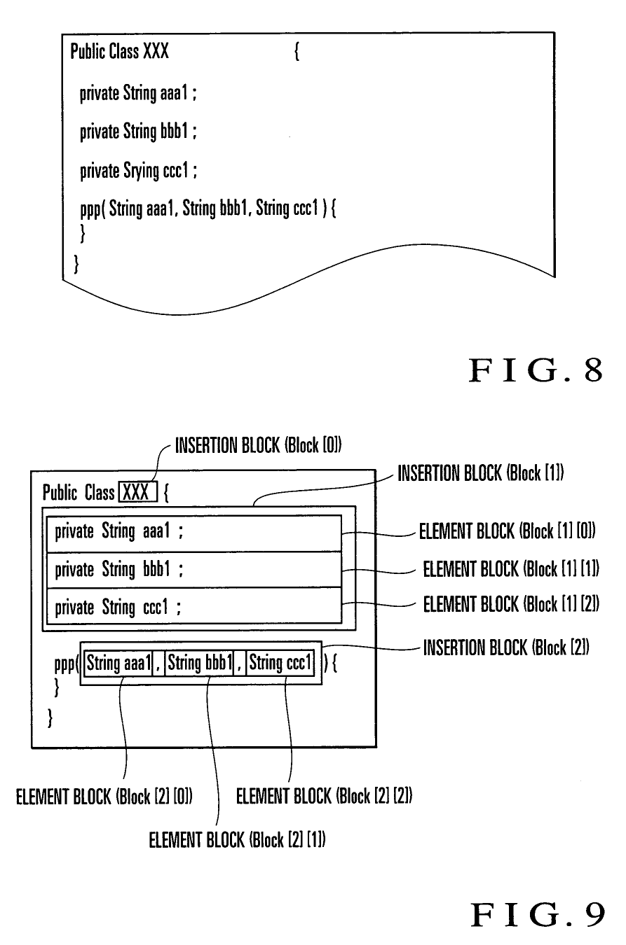

Referring to FIG. 2B which shows the subroutine invoked in step A2 described above, first, the text input unit 1 inputs the text of the case in accordance with the user's desire and stores the text in the text storage unit 2 (step A21). FIG. 8 shows an example of the text input as a case. Referring to FIG. 8, a program source code is used as an example of the text. However, the present invention is not limited to this. In the present invention, the texts widely include all texts expressed by characters. Another example may be the HTML source of a Web page.

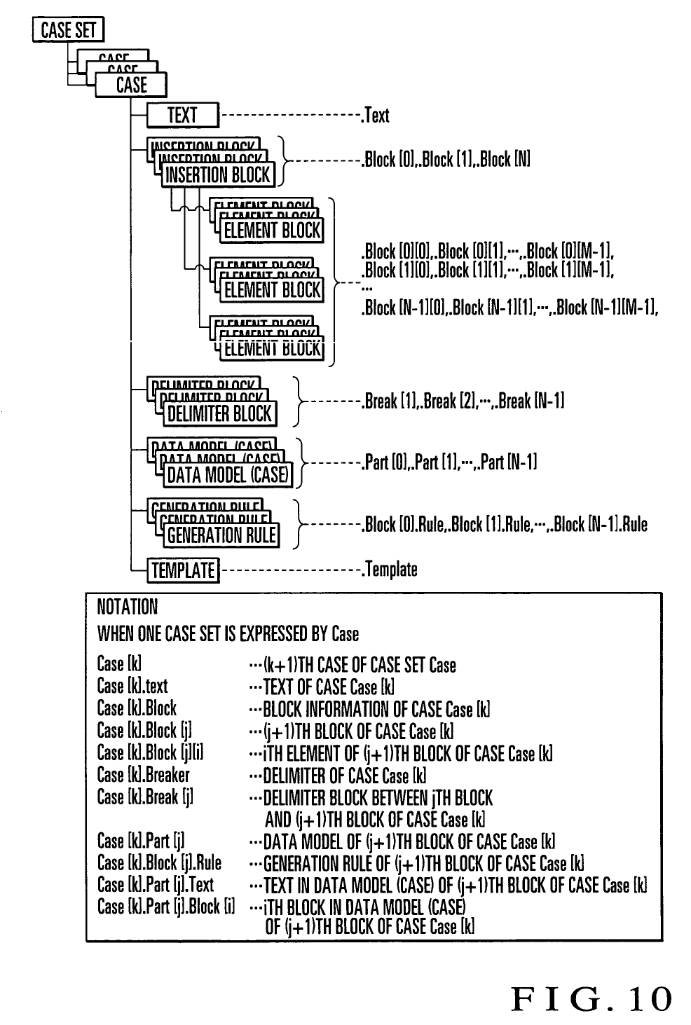

The block information input unit 3 presents, to the user, the text stored in the text storage unit 2. The block information input unit 3 designates, as block information, the range which should be defined as a block in the text in accordance with the user's operation and stores the block information in the block information storage unit 4 (step A22). FIG. 9 shows an example of a manner to separate block information input as a case. Block information here is information which explicitly indicates blocks formed by separating partial character strings in the text, as shown in FIG. 9.

The block information contains at least one insertion block. An insertion block is a block in which a character string generated from the data model should be inserted in the template. In the example shown in FIG. 9, Block[0], Block[1], and Block[2] are insertion blocks.

Insertion blocks are classified into those having a repetitive structure including a plurality of element blocks and those without any repetitive structure. An element block is the block of an element repeated in an insertion block having a repetitive structure. In the example shown in FIG. 9, the insertion block Block[1] has a repetitive structure including element blocks Block[1][0] to Block[1][2]. The insertion block Block[2] has a repetitive structure including element blocks Block[2][0] to Block[2][2]. However, the insertion block Block[0] has no repetitive structure.

Repetitive structures are classified into those having a delimiter block and those without any delimiter block. A delimiter block is a block which is left by excluding element blocks from an insertion block having a repetitive structure. In the example shown in FIG. 9, the repetitive structure of the insertion block Block[2] has delimiter blocks (character string “,”). The repetitive structure of the insertion block Block[1] has no delimiter block.

The block information contains pieces of information representing display of the corresponding text and the start and end positions of each of the insertion blocks, element blocks, and delimiter blocks.

When the texts of a plurality of cases are input in correspondence with one template to be created, block information is input for each text. In this case, blocks are defined such that partial character strings except the blocks coincide with each other, and the layouts and names of the blocks overlap each other for the texts of all cases.

Referring to FIG. 9, Block[0] and Block[1] given to the insertion blocks and Block[0][0], Block[0][1], and Block[0][2] given to the element blocks are examples of block names. In this embodiment, a name is given not only to each block but also to each of the texts, block information, data models, generation rules, and templates.

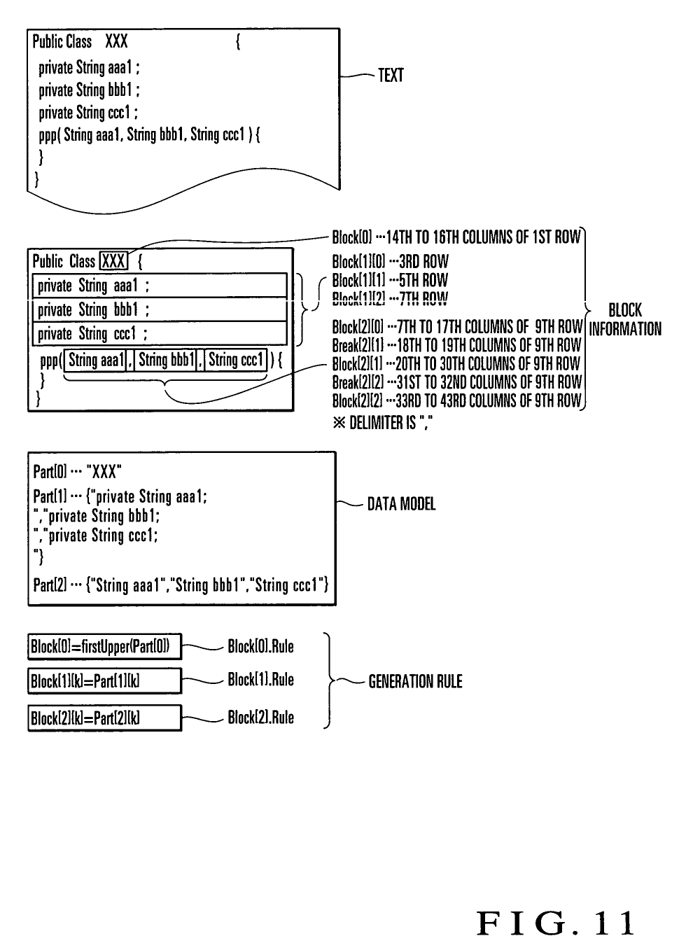

FIG. 10 shows the structure of a case set used in the first embodiment, examples of names given to the pieces of information, and their notations. The upper part of FIG. 10 shows the structure of a case set including a plurality of cases and examples of information names contained in the case set. The lower part of FIG. 10 shows the list of notations as the base of the names. In the example shown in FIG. 10, the case set is named Case. The plurality of cases included in the case set are named Case[k] in which k is the case number and starts from “0”. The (k+1)th case has a name Case[k].

Block information is named Block. An insertion block in the block information is named Block[j] in which j is the insertion block number and also starts from “0”. The (j+1)th insertion block in the case Case[k] is represented by Case[k].Block[j]. An element block in the insertion block Block[j] is named Block[j][i] in which i is the element block number in the insertion block and also starts from “0”.

A delimiter is named Breaker. The delimiter block between the jth block and the (j+1)th block is Break[j]. A data model is named Part. A generation rule is names Rule. Referring to FIG. 10, a template is included in the case. This is not the template as the final creation target of the template creation apparatus but a template generated in each case during the process of creating the template as the creation target.

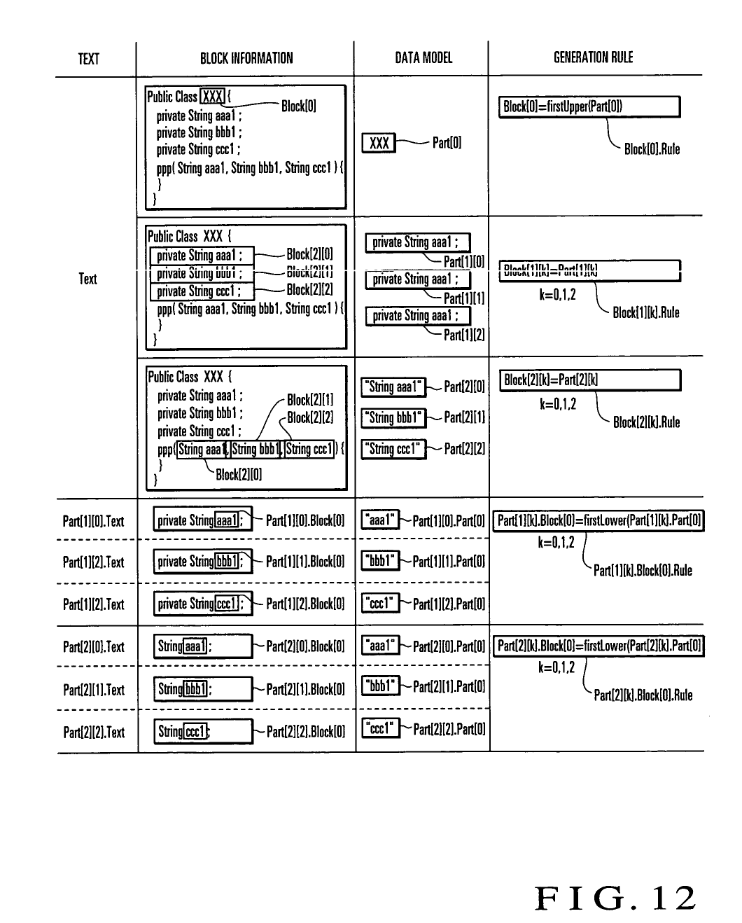

FIG. 11 shows content examples of the information according to the first embodiment. Referring FIG. 11, the block information contains pieces of information representing the start and end positions of each of the insertion blocks, element blocks, and delimiter blocks. For example, the start position of the insertion block Block[0] is the 14th column of the first row in the text. The end position is the 16th column of the first row.

Next, the data model input unit 5 inputs, in accordance with the user's desire, a data model corresponding to each block of the block information stored in the block information storage unit 4 and stores the data model in the data model storage unit 6 (step A23). For example, the data model input unit 5 presents, to the user, the text in the range enclosed by the block information, and inputs a data model corresponding to an insertion block and/or element block in that range in accordance with the user's operation. The data model corresponds to a partial character string enclosed by the block information in the text. When manipulation processing is executed for the data model in accordance with a generation rule, the partial character string in each block of the text is generated.

Referring to FIG. 10, a data model is named Part[j] in which j is the number of the corresponding block. A partial text in the data model Part[j] is named Part[j].Text. A block in the data model Part[j] is named Part[j].Block[i] in which i is the block number and starts from “0”.

FIG. 11 shows data models Part[0] to Part[2] corresponding to the insertion blocks Block[0] to Block[2] in the block information. The character strings of the respective element blocks are directly shown in the data models Part[0] to Part[2].

Next, in accordance with the user's operation, the generation rule input unit 7 inputs, as a generation rule, a functional relational expression representing the relationship between the block information stored in the block information storage unit 4 and the data model stored in the data model storage unit 6 and stores the generation rule in the generation rule storage unit 8 (step A24). Referring to FIG. 10, the generation rule of each insertion block Block[j] is named a generation rule Block[j].Rule in which j is the number of the corresponding block.

In the example shown in FIG. 11, a generation rule Block[0].Rule expresses that a result obtained by applying a function firstUpper(Part[0]) to the data model Part[0] should be inserted in the insertion block Block[0]. A generation rule Block[1].Rule expresses that a data model Part[1][0] should be inserted directly in the element block Block[1][0], a data model Part[1][1] should be inserted directly in the element block Block[1][1], and a data model Part[1][2] should be inserted directly in the element block Block[1][2].

Steps A21 to A24 indicate the processing of the subroutine in FIG. 2B. When this processing is ended, the template creation apparatus returns to the determination in step A1 in the main routine shown in FIG. 2A.

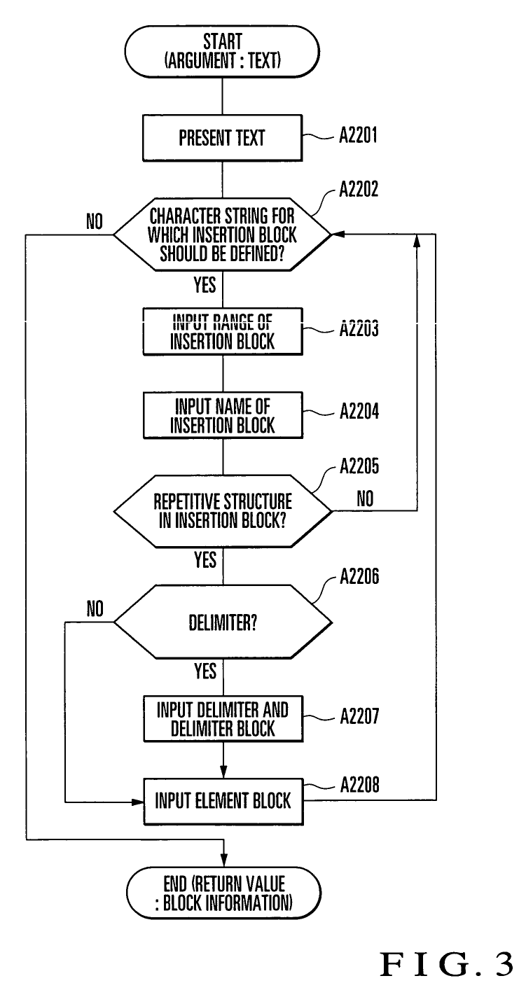

FIG. 3 shows details of the operation in step A22 shown in FIG. 2B. Referring to FIG. 3, first, the block information input unit 3 presents, to the user, the text which is input in step A21 as the case of template creation (step A2201).

Next, the block information input unit 3 determines by verifying with the user whether the presented text has a character string for which an insertion block should be defined (step A2202). For example, a plurality of samples of the text to be generated by using the template are input. Parts common to the plurality of texts are excluded from insertion blocks as invariable portions. Each of the remaining parts is defined as an insertion block as a variable portion. In this example, it is determined by verifying with the user whether a portion which should be defined as an insertion block is present. However, the present invention is not limited to this. For example, the template creation apparatus may automatically do the determination in accordance with the above-described determination.

If a character string to be defined as an insertion block still remains, the block information input unit 3 inputs the range of the character string to be defined as an insertion block in accordance with the user's desire (step A2203). For, e.g., the insertion block Block[0] shown in FIG. 11, the information of the range (14th to 16th columns of first row) enclosing the character string “XXX” is input.

Subsequently, the block information input unit 3 inputs the block name of the range input in step A2203 in accordance with the user's desire (step A2204). For, e.g., the first insertion block in FIG. 11, “Block[0]” is input as the block name. The block information input unit 3 verifies with the user whether the insertion block input in step A2203 has a repetitive structure (step A2205). If the insertion block has no repetitive structure, the block information input unit 3 returns to the processing in step A2202. For example, the insertion block Block[0] shown in FIG. 11 has no repetitive structure, the block information input unit 3 returns to the processing in step A2202.

If the insertion block has a repetitive structure, it is determined by verifying with the user whether the repetitive structure has a character string serving as a delimiter block (step A2206). If a character string serving as a delimiter block is present, the block information input unit 3 inputs the delimiter and the range of the delimiter block in accordance with the user's desire (step A2207). For, e.g., the insertion block Block[2] of the block information shown in FIG. 11, “,” is input as a delimiter. As the range of the delimiter block Break[2][1] which separates the first element block Block[2][0] and the second element block Block[2][1], “18th to 19th columns of ninth row” is input. As the range of the delimiter block Break[2][2] which separates the second element block Block[2][1] and the third element block Block[2][2], “31st to 32nd columns of ninth row” is input.

When the processing in step A2207 is ended, or it is determined in step A2206 that no character string serving as a delimiter block is present, the block information input unit 3 inputs the range of an element block in the repetitive structure in the insertion block in accordance with the user's desire (step A2208) and returns to the processing in step A2202 (step A2202). If a character string for which an insertion block should be defined remains in the text, the processing in steps A2202 to A2208 is repeated. The insertion blocks need not be parallel to each other. A smaller insertion block can also be defined in an insertion block.

For example, in the insertion block Block[2] shown in FIG. 11, the ranges of the three element blocks Block[2][0] to Block[2][2] in the repetitive structure are input as “7th to 17th columns of ninth row”, “20th to 30th columns of ninth row”, and “33rd to 43rd columns of ninth row”, respectively. If it is determined in step A2202 that no character string to be defined as an insertion block is present, the block information input unit 3 ends the series of processing operations. For example, referring to FIG. 11, when all pieces of block information of the insertion blocks Block[0] to Block[2] are input, no character string for which a block is to be defined remains.

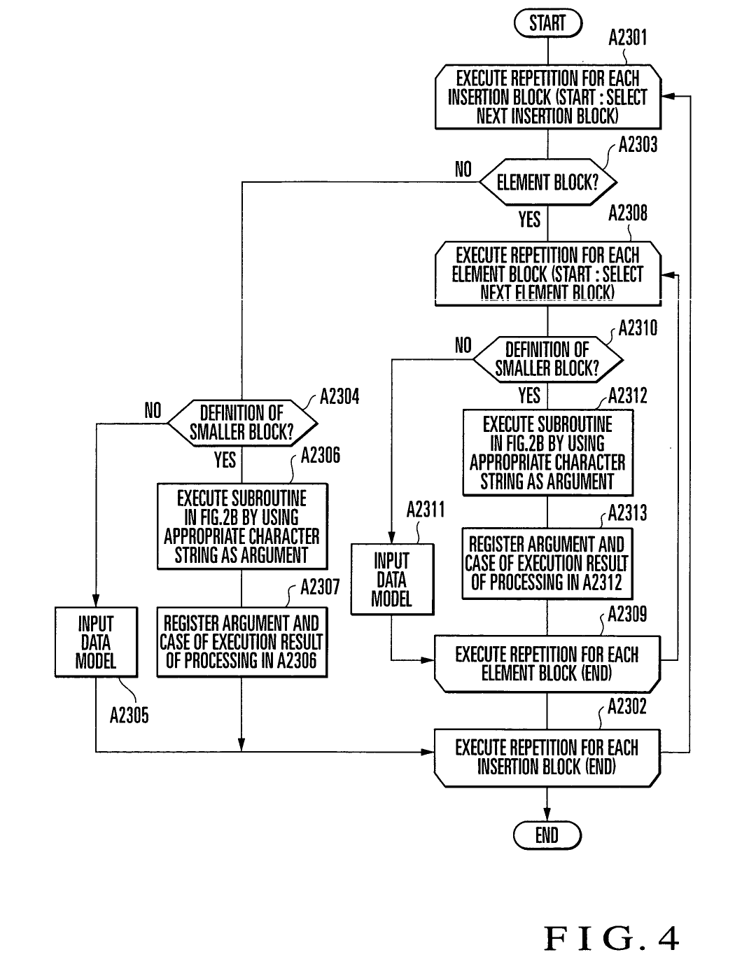

FIG. 4 shows details of the operation in step A23 shown in FIG. 2B. Referring to FIG. 4, the data model input unit 5 repeats the processing between steps A2301 and A2302, thereby inputting a data model for each insertion block of the block information. For example, in the block information shown in FIG. 11, the processing between steps A2301 and A2302 is executed for each of the insertion blocks Block[0], Block[1], and Block[2]. First, the data model input unit 5 selects one insertion block from the block information (step A2301) and determines whether the insertion block includes element blocks (step A2303).

If no element block is present, the data model input unit 5 determines by verifying with the user whether a smaller insertion block is to be defined in the insertion block (step A2304). If a character string for which a smaller insertion block is to be defined is present, the data model input unit 5 executes the subroutine shown in FIG. 2B by using, as an argument, the character string for which a smaller insertion block is to be defined (step A2306). The data model input unit 5 registers, as a data model, the argument of the processing in step A2306 and the case obtained as the result of execution (step A2307). This case contains a combination of the character string of the argument corresponding to the text and the block information, data model, generation rule, and template as the return values of the subroutine execution result. A hierarchical structure is formed so that another case is present in the data model. Input of the data model of one insertion block is thus ended, and the processing from step A2301 is executed for the next insertion block.

If it is determined in step A2304 that no character string for which a smaller insertion block is to be defined is present, the data model input unit 5 inputs the data model in accordance with the user's operation (step A2305). At this time, the data model input unit 5 creates the data model in accordance with the structure of the insertion block, presents, to the user, the character string of the insertion block as the default value of the contents of the data model, and stores the character string of the contents of the data model in the data model storage unit 6 in accordance with the user's desire. As another example, the data model input unit 5 may automatically input the default value as the character string of the contents of the data model without intervention of the user. Input of the data model of one insertion block is thus ended, and the processing from step A2301 is executed for the next insertion block.

If it is determined in step A2303 that the insertion block has element blocks, the processing between steps A2308 and A2309 is repeated to input a data model for each element block. For example, the insertion block Block[2] shown in FIG. 11 has a repetitive structure. Hence, the processing is repeated three times for the element blocks Block[2][0] to Block[2][2].

At this time, the data model input unit 5 determines by verifying with the user whether a smaller insertion block is to be defined in the element block (step A2310). If a character string for which a smaller insertion block is to be defined is present, the data model input unit 5 executes the subroutine shown in FIG. 2B by using, as an argument, the character string for which a smaller insertion block is to be defined (step A2312). The data model input unit 5 registers, as a data model, the argument of the processing in step A2312 and the case obtained as the result of execution (step A2313). This case contains a combination of the character string of the argument corresponding to the text and the block information, data model, generation rule, and template as the return values of the subroutine execution result. For this reason, a hierarchical structure is formed so that another case is present in the data model. Input of the data model of one element block is thus ended, and the processing from step A2308 is executed for the next element block.

If it is determined in step A2310 that no character string for which a smaller insertion block is to be defined is present, the data model input unit 5 inputs the data model in accordance with the user's desire (step A2311). At this time, the data model input unit 5 creates the structure of the data model in accordance with the structure of the element block, presents, to the user, the character string of the element block as the default value of the contents of the data model, and stores the character string of the contents of the data model in the data model storage unit 6 in accordance with the user's desire. As another example, the data model input unit 5 may automatically input the default value as the character string of the contents of the data model without intervention of the user.

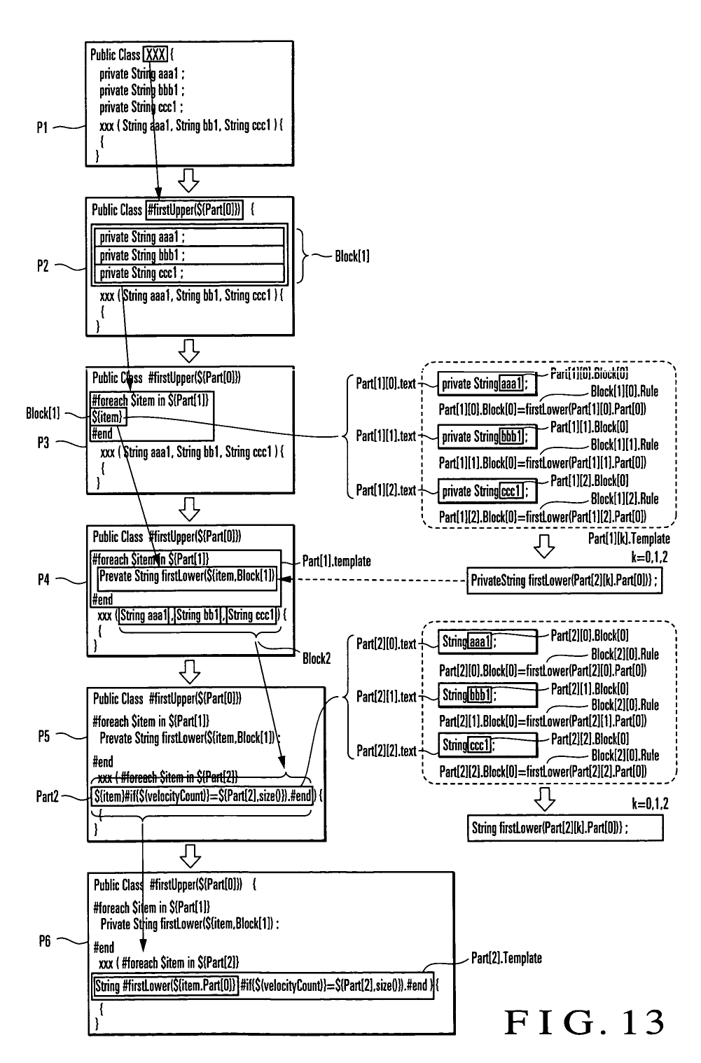

FIG. 12 shows the information set of the case obtained by executing the processing shown in FIG. 2B for the text shown in FIG. 8. The processing shown in FIG. 2B has a recursive structure. When the series of processing operations in FIG. 2B are executed for the text, a case associated with each block which is present in the hierarchical structure in the text is obtained in addition to the case for the entire text. FIG. 12 shows an example of two-step recursive processing so that the cases of the data models Part[1] and Part[2] of the blocks are present in correspondence with the original Text. Generally, the processing can have any number of steps.

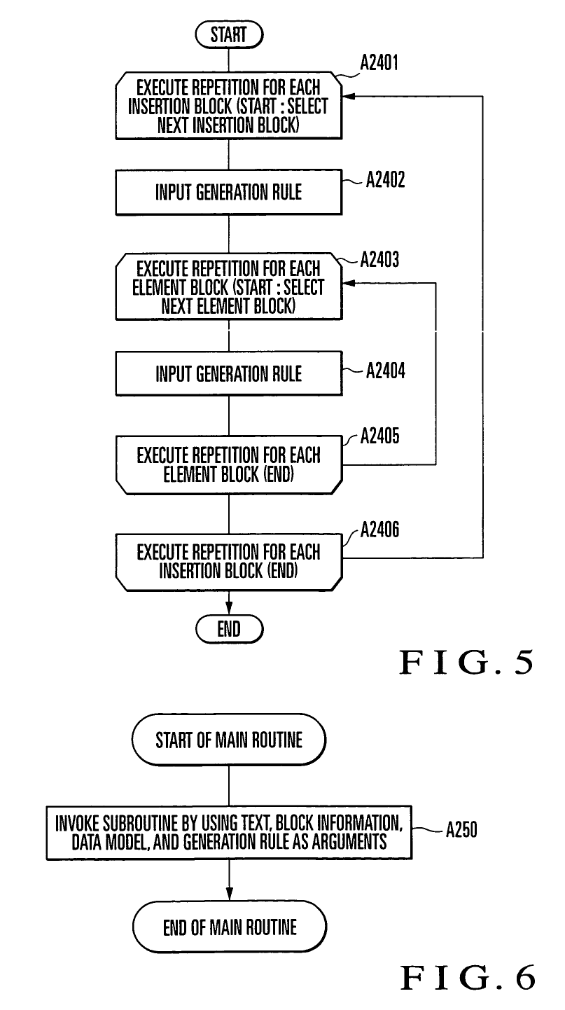

FIG. 5 shows details of the operation in step A24 shown in FIG. 2B. Referring to FIG. 5, the generation rule input unit 7 repeats the processing in steps A2401 and A2406 for each insertion block, thereby inputting the generation rule of each insertion block contained in the block information.

First, the generation rule input unit 7 selects one insertion block in the block information (step A2401). The generation rule input unit 7 presents, to the user, a default generation rule, i.e., a generation rule to insert the data model of the selected insertion block in the insertion block without any manipulation processing and inputs the generation rule of the insertion block in accordance with the user's desire (step A2402). As another example, the generation rule input unit 7 may automatically input the above-described default generation rule.

Next, the generation rule input unit 7 repeats the processing in steps A2403 and A2405 for each element block, thereby inputting the generation rule of each element block. First, the generation rule input unit 7 selects one element block in the insertion block (step A2403). The generation rule input unit 7 presents, to the user, a default generation rule, i.e., a generation rule to insert the data model of the selected element block in the element block without any manipulation processing and inputs the generation rule of the element block in accordance with the user's operation (step A2404). As another example, the generation rule input unit 7 may automatically input the above-described default generation rule.

The generation rule input unit 7 repeats the processing number of times corresponding to the numbers of element blocks and insertion blocks. When all insertion blocks are selected, the series of processing operations are ended. By the series of processing operations of the subroutine shown in FIG. 2B, generation rules shown on the rightmost column of FIG. 12 are obtained.

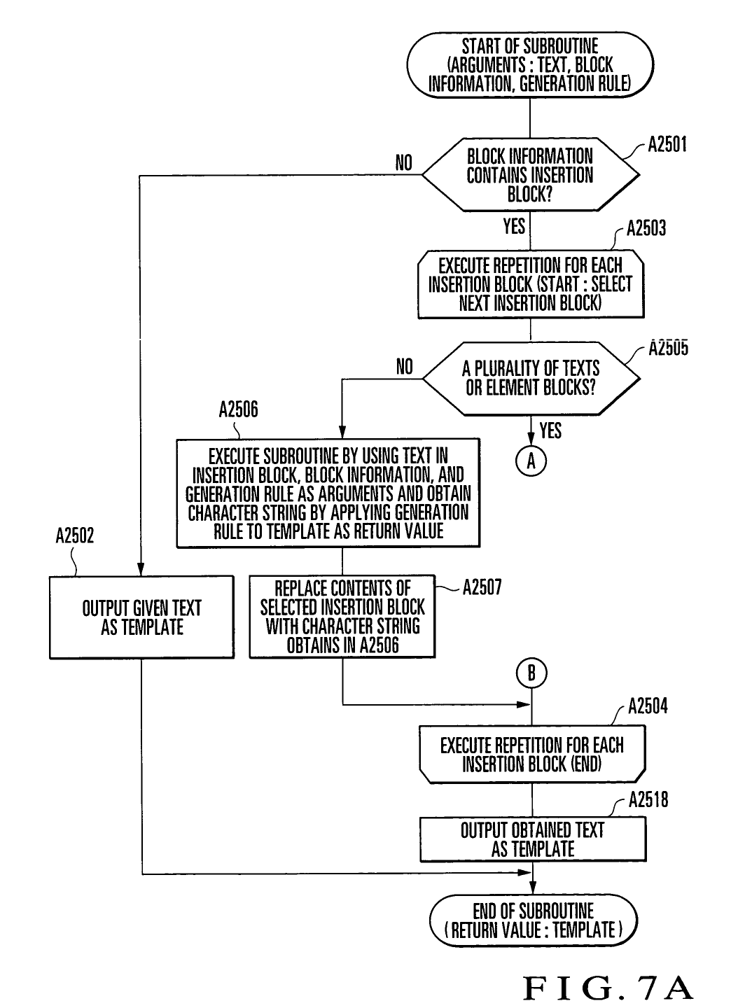

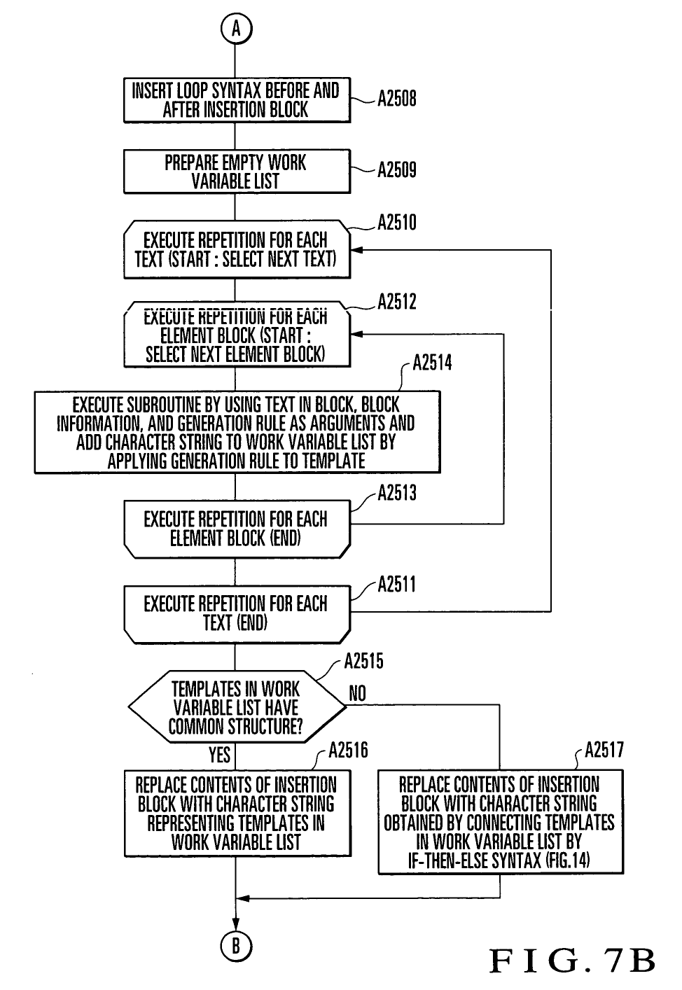

FIG. 6 shows the main routine of the operation in step A25 shown in FIG. 2B. FIGS. 7A, 7B, and 8 show the subroutine of the operation in step A25 shown in FIG. 2B. Although the subroutine is divisionally shown in FIGS. 7A, 7B, and 8 for the illustrative convenience, these are a series of processing operations.

Referring to FIG. 6, the template generation unit 9 invokes the subroutine shown in FIGS. 7A and 7B by using, as arguments, the text to be used for creation of the template and the block information and generation rules associated with the text (step A250). One or a plurality of texts can be used for generation of the template. When a plurality of texts are used, a plurality of cases corresponding to them are used as arguments. The texts, block information, and generation rules as the arguments of the subroutine can be read out from the text storage unit 2, block information storage unit 4, and generation rule storage unit 8.

Referring to the subroutine shown in FIGS. 7A and 7B, first, the template generation unit 9 determines whether the block information has an insertion block (step A2501). If the block information has no insertion block, the template generation unit 9 outputs the text as the template (step A2502) and ends the processing of the subroutine. If the block information has an insertion block, the template generation unit 9 repeats the processing between steps A2503 and S2504 for each insertion block contained in the block information. When the processing is ended for all insertion blocks, the text obtained as the result is output as the template (step 2518), and the processing of the subroutine is ended.

As the processing from step A2503 to A2504, first, the template generation unit 9 selects one insertion block from the block information (step A2503). The template generation unit 9 determines whether a plurality of texts are used for generation of one template or whether the selected insertion block has element blocks (step A2505).

If only one text is used, and the insertion block has no element block, the template generation unit 9 recursively executes the subroutine shown in FIG. 7B by using, as arguments, the text in the insertion block and the block information and generation rule associated with the text. A template as a return value is handled as a data model. The generation rule is applied to the data model to acquire a character string (step A2506). The template generation unit 9 replaces the contents of the selected insertion block with the character string obtained in step A2506 (step A2507) and ends the processing for that insertion block. If repetition is further necessary, the flow returns to step A2503 (step A2504).

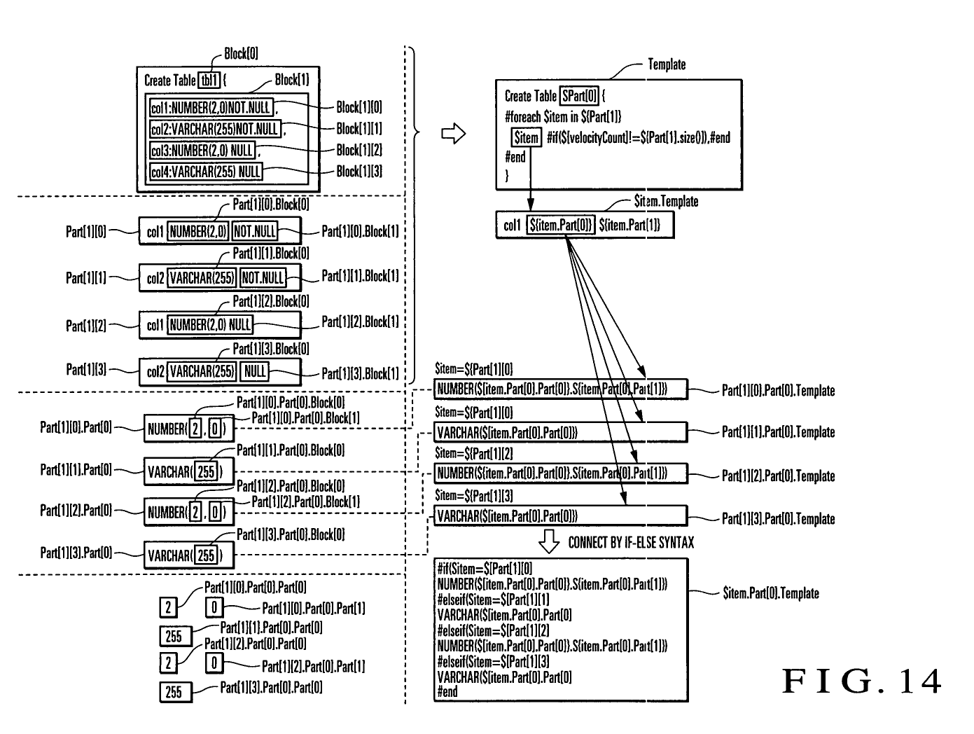

FIG. 13 explains the outline of processing by the template generation unit 9 of the first embodiment. In the processing from P3 to P4 in FIG. 13, the insertion block Block[1] will be focused. The insertion block Block[1] contains the text Part[1][k].Text. In this example, k=0, 1, 2. When the subroutine is recursively executed by using, as arguments, the text Part[1][k].Text, block information Part[1][k].Block[0], data model Part[1][k].Part[0], and generation rule Block[1][k].Rule[0], templates Part[1][k].Template (k=0, 1, 2) are obtained and defined as the contents of the insertion block Block[1].

If it is determined in step A2505 that a plurality of texts are used, or element blocks are present, the template generation unit 9 inserts a loop syntax to express a repetitive structure before and after the insertion block (step A2508). For example, in the processing from P2 to P3 in FIG. 13, a loop syntax is inserted before and after the insertion block Block[1].

Next, the template generation unit 9 prepares a work variable list and initializes its contents to empty (step A2509). A work variable list contains variables having a list structure and can hold the elements of the list in a template. To generate a character string to be inserted in one insertion block, character strings obtained from a plurality of texts or a plurality of element blocks are listed in the work variable list. The character strings listed in one work variable list are character strings associated with, e.g., one insertion block.

The template generation unit 9 repeats the processing between steps A2510 and A2511 for each element block. At this time, the template generation unit 9 selects one of the plurality of texts and repeats the processing between steps A2512 and A2513 for each element block. When only one text is used, the template generation unit 9 executes the processing between steps A2512 and A2613 only once.

The template generation unit 9 selects one block from the insertion blocks (step A2512). The template generation unit 9 recursively invokes and executes the subroutine shown in FIG. 7B by using, as arguments, the text in the block and the block information and generation rule associated with the text. A template as a return value is handled as a data model. A character string obtained by applying the generation rule to the data model is added to the work variable list (step A2514). If at least one of the conditions is satisfied in step A2505, i.e., it is determined that element blocks are present, or a plurality of texts are used, the processing from step A2512 to A2513 is executed. When the insertion block has element blocks, the block selected in step A2512 is each element block. When a plurality of texts are used, and no element block is present in the insertion block, the block selected in step A2512 is the insertion block itself in each text.

P3 in FIG. 13 indicates the result obtained by executing the processing in step A2512 for each element block of the block information Part[1]. When the processing of the subroutine shown in FIG. 7B is executed for the texts Part[1].text[0], Part[1].text[1], and Part[1].text[2] in the data model Part[1] corresponding to the insertion block Block[1], templates Part[1][k].Template (k=0, 1, 2) are obtained. When the processing is repeated for all element blocks, and no unselected element block remains, the template generation unit 9 determines whether the structures of the templates in the work variable list are common (step A2515).

If all the structures of the templates in the work variable list are common, the template generation unit 9 replaces the contents of the selected insertion block with a character string which represents the templates in the work variable list (step A2516) and ends the processing for the insertion block. If repetition is further necessary, the flow returns to step A2503 (step A2504). A character string which represents the templates indicates a character string which achieves the commonality of the expressions of the templates by setting different parts between them to a variable. For example, if only the block number changes between the templates, that part is set as a variable. Accordingly, an expression which achieves the commonality of the templates can be obtained.

P4 in FIG. 13 indicates a state in which a character string which represents the three templates Part[1][k].Template (k=0, 1, 2) in the work variable list is embedded in the insertion block Block[1]. The commonality of the templates is achieved by using a variable ${item,Block[1]}. Similarly, in the processing for P5 to P6 in FIG. 13, a character string which represents the three templates in the work variable list for the processing result for Part[2] is embedded in the insertion block Block[2].

If it is determined in step A2515 that the structures of the templates in the work variable list are not common, the template generation unit 9 replaces the contents of the selected insertion block with a character string obtained by connecting the templates in the work variable list by the if-then-else syntax (step A2517) and ends the processing for the insertion block. If repetition is further necessary, the flow returns to step A2503 (step A2504).

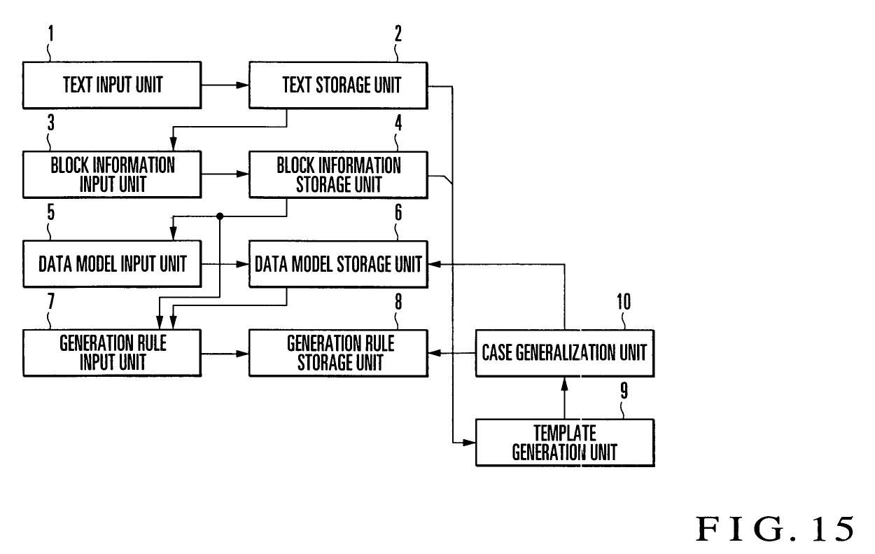

FIG. 14 shows a detailed example of the processing in step A2517 shown in FIG. 7B. Referring to FIG. 14, the insertion block Block[1] has four element blocks Block[1][0] to Block[1][3]. Templates Part[1][0].Part[0].Template to Part[1][3].Part[0].Template corresponding to the element blocks Block[1][0] to Block[1][3] have different structures. For this reason, the templates are connected by the if-else syntax.

When the processing is repeated for all insertion blocks, and no unselected insertion block remains, the template generation unit 9 outputs the obtained text as a template and ends the subroutine (step A2518). P6 in FIG. 13 indicates an example of the output template.

According to the template creation apparatus of the above-described first embodiment, the text input unit 1 inputs the text of a case. The block information input unit 3 inputs the block information of the text.

The data model input unit 5 inputs the data model of each block. The generation rule input unit 7 inputs a generation rule to generate a character string of the contents of each block from the data model. The template generation unit 9 removes overlap between the element blocks and between the texts while generating, in accordance with the generation rule, the character string of the contents of each block as a replaceable portion in the template. Hence, the specifications of the template are easily determined on the basis of the text as the case and the block information, data models, and generation rules associated with the text.

Since the specifications of a template can be defined by inputting a text, block information, data models, and generation rules whose contents are easy to grasp, the specifications of a complex template can intuitively and easily be defined. In addition, the specifications of the template can be reviewed by checking the block information, data models, and generation rules for the text of the case. Hence, the specifications of the template can very easily be reviewed without any necessity to directly check the complex template.

In the conventional debug method of directly editing a template, a template engine must be applied to a template which is undergoing debug to obtain a text generation result, and then, errors at the time of generation or compile errors in the generation result must be checked and removed. According to the template creation apparatus of this embodiment, however, the template creation apparatus mechanically creates a template in accordance with given specifications without causing a user to directly edit the template. No syntax errors can occur in the template. In addition, debug can be executed only by editing the case without generating any text by using the template. A measure against a compile error can easily be taken, and debug can efficiently be executed.

Furthermore, since the specifications of the template are given by cases, no alienation between the requested specifications and the actually created template occurs in principle. It is only necessary to verify whether the specifications themselves are appropriate. Since the coincidence between the specifications and the template need not be verified, the test of the template can efficiently be done.

In this embodiment, in generating a template, the template generation unit 9 removes the overlap between a plurality of texts and between insertion blocks but executes no processing for the overlap between insertion block in the template. However, the present invention is not limited to this. When there is an overlap between insertion blocks in the template, the template generation unit 9 may generate a template which achieves the commonality of the insertion blocks. For example, when insertion blocks which are common except parts corresponding to the block numbers are present in the template, the template generation unit 9 replaces the insertion blocks with new insertion blocks that represent them.

The second embodiment of the present invention will be described with reference to the accompanying drawings.

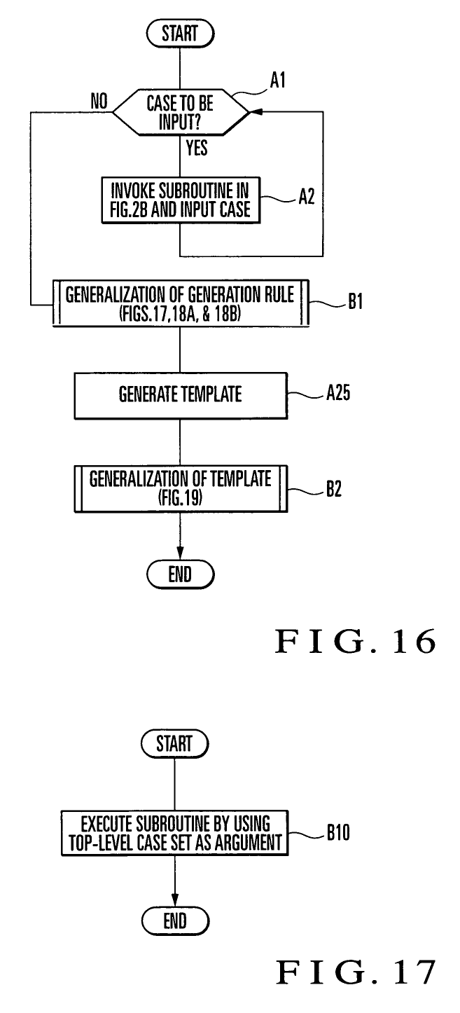

FIG. 15 shows the arrangement of a template creation apparatus according to the second embodiment of the present invention. Referring to FIG. 15, the template creation apparatus according to the second embodiment comprises a text input unit 1, text storage unit 2, block information input unit 3, block information storage unit 4, data model input unit 5, data model storage unit 6, generation rule input unit 7, generation rule storage unit 8, template generation unit 9, and case generalization unit 10. The text input unit 1, text storage unit 2, block information input unit 3, block information storage unit 4, data model input unit 5, data model storage unit 6, generation rule input unit 7, generation rule storage unit 8, and template generation unit 9 are the same as in the first embodiment shown in FIG. 1, and a description thereof will be omitted.

The case generalization unit 10 reduces the redundancy of the data model stored in the data model storage unit 6 and the generation rule stored in the generation rule storage unit 8. The case generalization unit 10 also reduces the redundancy of the template generated by the template generation unit 9. If insertion blocks have a common data model, the case generalization unit 10 detects it and sets the character string of the common data model of the insertion blocks to the data model common to the insertion blocks. If element blocks have a common data model, the case generalization unit 10 detects it and sets the character string of the common data model of the element blocks to the data model common to the element blocks. If a template generated by the template generation unit 9 has an if-then-else syntax portion, and the character strings connected by the if-then-else syntax have a plurality of common character strings, the case generalization unit 10 removes the plurality of character strings from the if-then-else syntax. Instead, a character string which represents the plurality of character strings is included in the if-then-else syntax.

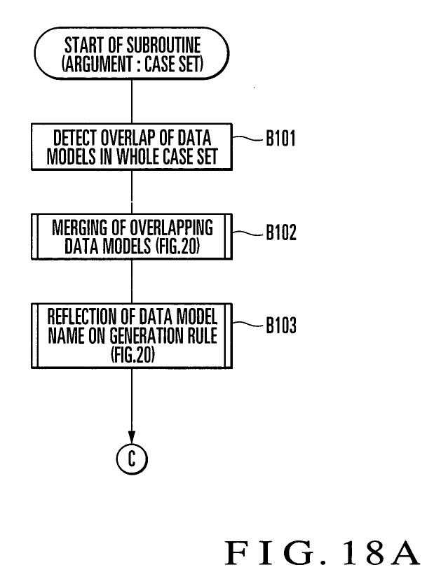

FIG. 16 shows the operation of the template creation apparatus according to the second embodiment. FIG. 16 shows only the main routine. The subroutine is the same as in FIG. 2B. In the main routine shown in FIG. 16, the same step numbers as in FIG. 2A indicate the same processing. Referring to FIG. 16, first, the template creation apparatus inputs a desired number of cases by repeating steps A1 and A2.

Next, the case generalization unit 10 generalizes the generation rule (step B1). The template generation unit 9 creates a template on the basis of the cases, as in the above-described first embodiment (step A25). Finally, the case generalization unit 10 generalizes the template generated by the template generation unit 9 (step B2).

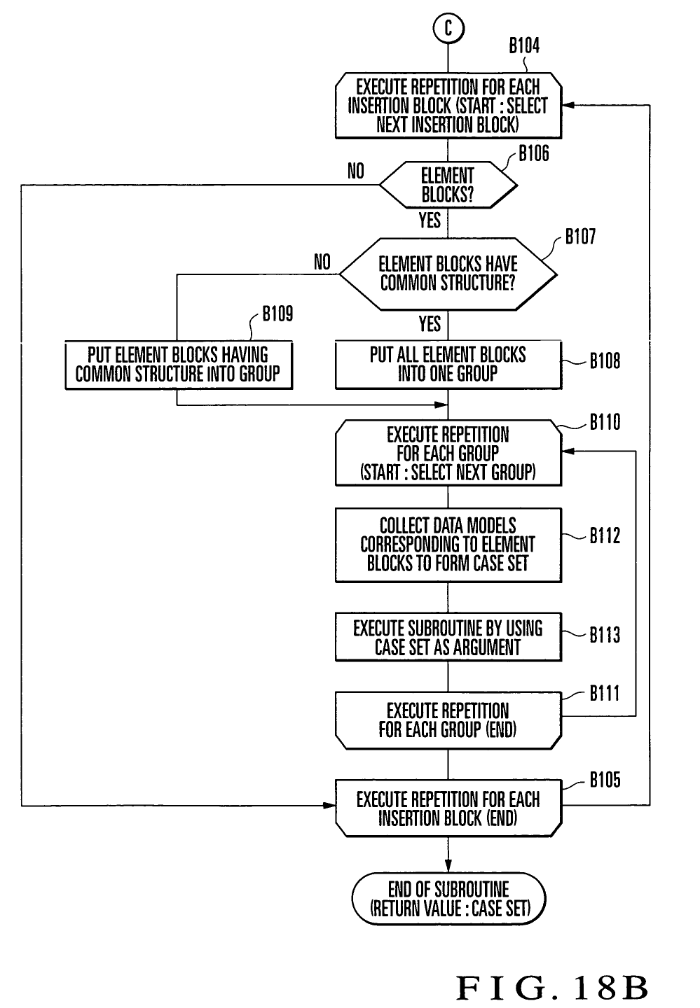

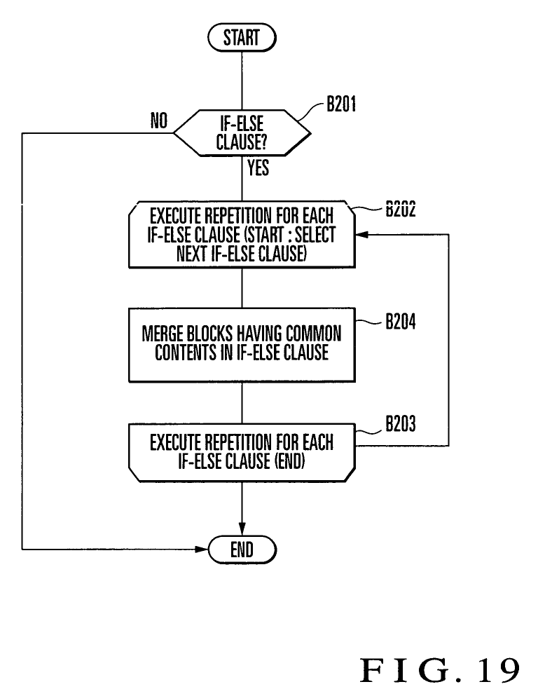

FIG. 17 shows the main routine of the operation in step B1 shown in FIG. 16. FIGS. 18A and 18B show the subroutine of the operation in step B1 shown in FIG. 16. Referring to the main routine in FIG. 17, the case generalization unit 10 executes the subroutine shown in FIGS. 18A and 18B by using the top-level case set as an argument (step B10). The top-level case set is a set of cases related to the first layer of the hierarchical structure in the text input by the text input unit 1 as a sample. One or a plurality of cases can be included in the case set.

Referring to the subroutine shown in FIGS. 18A and 18B, first, the case generalization unit 10 detects the overlap of data models in the whole case set given as an argument (step B101). If the case set includes common data models, they are detected. Next, the case generalization unit 10 merges the overlapping data models detected in step B101 to create a new data model (step B102). The case generalization unit 10 reflects the name of the new data model created in step B102 on the generation rule.

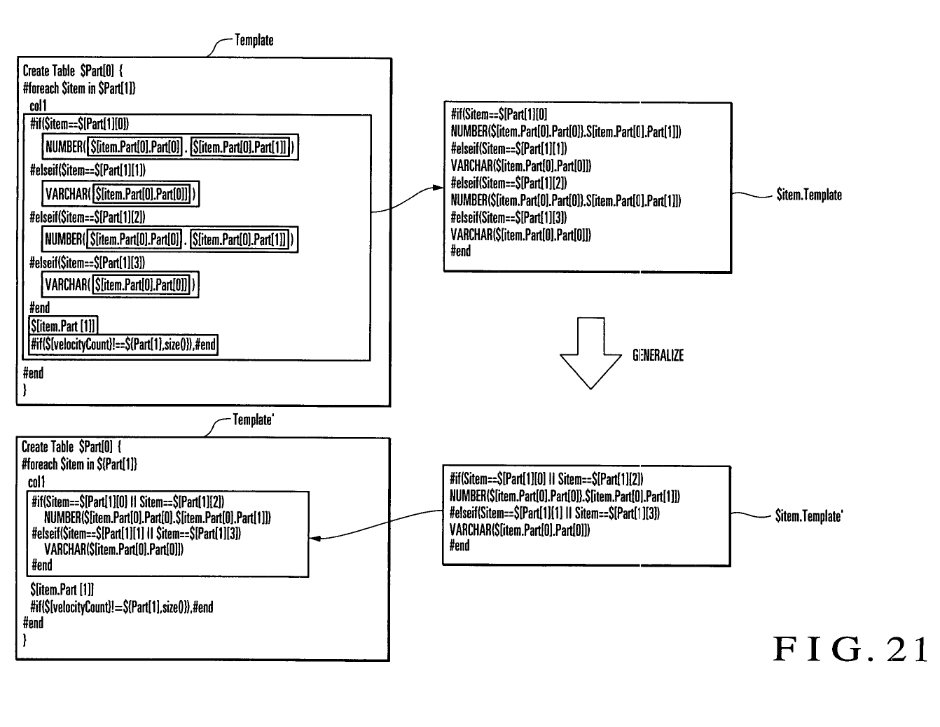

FIG. 20 shows a detailed example of the processing in steps B102 and B103 shown in FIG. 18A. Referring to FIG. 20, two data models Part[1] and Part[2] overlap. To simplify the template structure, the case generalization unit 10 merges them to create a new data model Part New and reflects the name of the new data model on a generation rule Part[j][k].Block[0].Rule (j=0, 1, k=0, 1, 2).

The case generalization unit 10 repeats the processing from step B104 to B105 shown in FIG. 18B for each insertion block. First, the case generalization unit 10 selects one insertion block from block information (step B104). The case generalization unit 10 determines whether the insertion block has element blocks (step B106). If element blocks are present, the case generalization unit 10 determines whether the element blocks in the insertion block have a common structure (step B107).

If all the element blocks have a common structure, the case generalization unit 10 puts all the element blocks into one group (step B108). If there are element blocks having different structures, the case generalization unit 10 puts element blocks having a common structure into one group (step B109). Hence, in some cases, the element blocks can be divided into a plurality of groups.

The case generalization unit 10 repeats the processing between steps B110 and B111 for each group. First, the case generalization unit 10 selects one group (step B110). The case generalization unit 10 collects data models corresponding to the respective element blocks in the group to form a case set to be processed (step B112). The case generalization unit 10 recursively invokes and executes the subroutine shown in FIGS. 18A and 18B by using, as an argument, the case set created in step B112 (step B113). The processing for one group is thus ended.

If an unselected group remains, the case generalization unit 10 executes the processing between steps B110 and B111 for the next group. If no unselected group remains, repetition for the groups of the insertion block is ended (step B111). The processing for one insertion block is thus ended. If an unselected insertion block remains, the case generalization unit 10 executes the processing from step B104 to B105 for the next insertion block. If no unselected insertion block remains, repetition for the insertion blocks of the block information is ended, and the processing of the subroutine is ended (step B105).

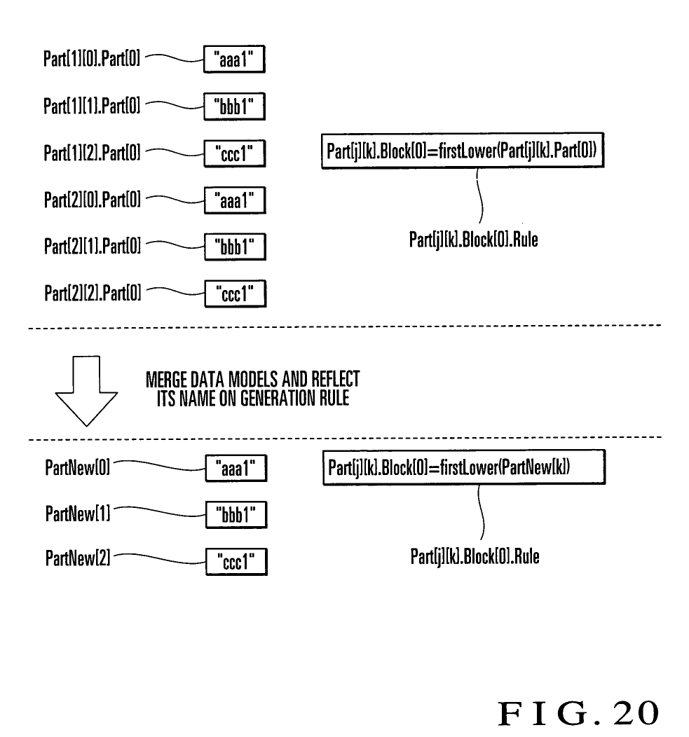

FIG. 19 shows details of the operation in step B2 shown in FIG. 16. The processing in step B2 is executed after the template is generated by the processing in step A25, as shown in FIG. 16. Referring to FIG. 19, the case generalization unit 10 determines whether the created template has clauses (if-else clauses) connected by the if-else syntax (step B201). If the template has no if-else clause, the case generalization unit 10 ends the processing.

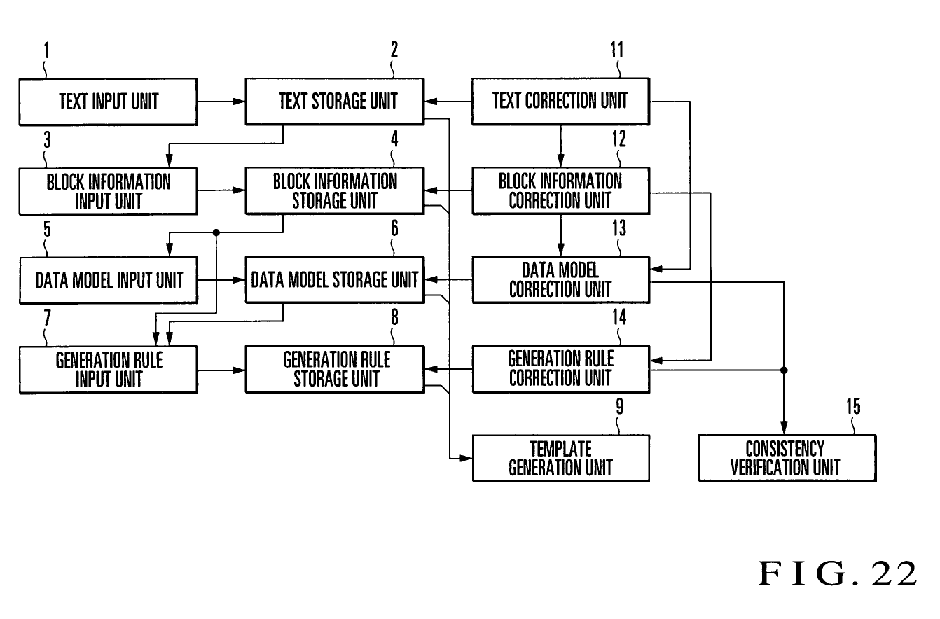

If the template has if-else clauses, the case generalization unit 10 repeats the processing from step B202 to B203 for the if-else clauses. At this time, the case generalization unit 10 merges blocks with common contents in each if-else clause (step B204). When the repetitive processing is ended for all the if-else clauses, and no unprocessed if-else clause remains, the case generalization unit 10 ends the processing. FIG. 21 shows a detailed example of the processing shown in FIG. 19. Referring to FIG. 21, a template Template has if-else clauses, and the if-else clauses have overlapping blocks. The case generalization unit 10 merges the overlapping blocks to generalize the if-else clauses.

In the above-described first embodiment, when the template creation apparatus automatically inputs default values without intervention of the user in, e.g., steps A2305, A2311, A2402, and A2404, the user can more easily create the template. In this case, however, if the data model contents have an overlap between a plurality of cases, a redundancy is generated in the generation rule. Additionally, in the first embodiment, in the processing in step A2515 by the template generation unit 9, a template having an overlap in the contents of a block including an if-else syntax can be generated.

On the other hand, according to the template creation apparatus of the second embodiment, if data models overlap between cases, between insertion blocks, or between element blocks, the case generalization unit 10 merges the data models to generalize the data model and generation rule. In addition, since the overlap in the if-else syntax in the template is removed, the redundancy of the data model, generation rule, and template can be reduced.

In FIGS. 18A and 18B and their description, commonality between element blocks has been focused for the descriptive convenience. However, the present invention is not limited to this. As in the first embodiment, when a plurality of texts are input, commonality between insertion blocks of the plurality of texts can also be achieved.

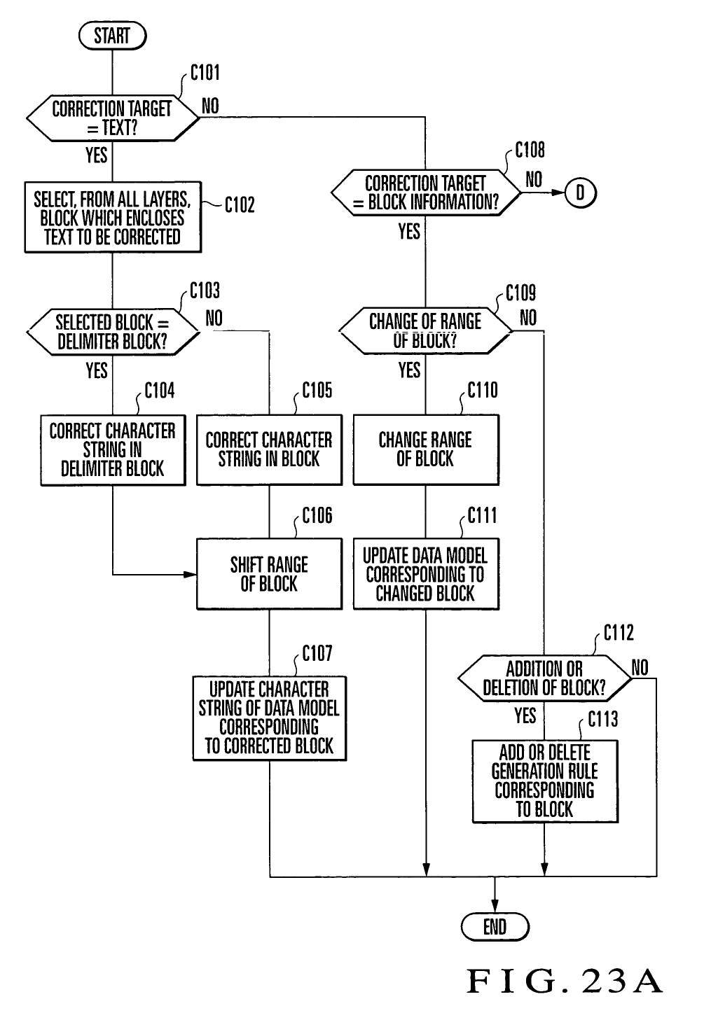

The third embodiment of the present invention will be described with reference to the accompanying drawings. FIG. 22 shows the arrangement of a template creation apparatus according to the third embodiment of the present invention. Referring to FIG. 22, the template creation apparatus of the third embodiment comprises a text input unit 1, text storage unit 2, block information input unit 3, block information storage unit 4, data model input unit 5, data model storage unit 6, generation rule input unit 7, generation rule storage unit 8, template generation unit 9, text correction unit 11, block information correction unit 12, data model correction unit 13, generation rule correction unit 14, and consistency verification unit 15. The text input unit 1, text storage unit 2, block information input unit 3, block information storage unit 4, data model input unit 5, data model storage unit 6, generation rule input unit 7, generation rule storage unit 8, and template generation unit 9 are the same as in the first embodiment shown in FIG. 1, and a description thereof will be omitted.

The text correction unit 11 corrects a text stored in the text storage unit 2 in accordance with the user's desire. The text correction unit 11 notifies the block information correction unit 12 and data model correction unit 13 of the correction contents to instruct them to correct block information and data models. Upon receiving the notification of the correction contents related to the text from the text correction unit 11, the block information correction unit 12 corrects block information by reflecting the correction contents. In addition, the block information correction unit 12 corrects the block information in accordance with the user's desire. The block information correction unit 12 notifies the data model correction unit 13 and generation rule correction unit 14 of the correction contents of the block information to instruct them to correct data models and generation rules.

Upon receiving the notification of the text correction contents and the data model correction instruction from the text correction unit 11, the data model correction unit 13 inputs the change contents of data models so as to reflect the correction contents of the text in accordance with the instruction. In addition, upon receiving the notification of the block information correction contents and the data model correction instruction from the block information correction unit 12, the data model correction unit 13 inputs the change contents of data models so as to reflect the correction contents of the block information in accordance with the instruction. Furthermore, the data model correction unit 13 inputs the change contents of the data models in accordance with the user's desire. The change contents of the data models are temporarily stored in, e.g., the data model storage unit 6.

The data model correction unit 13 notifies the consistency verification unit 15 of the change contents of the data models to instruct it to determine whether the change contents are consistent with the generation rules and text. When the determination result returned from the consistency verification unit 15 indicates that the change contents are consistent, the data model correction unit 13 changes the data models in the data model storage unit 6 in accordance with the change contents. When the determination result indicates that the change contents are not consistent, the data model correction unit 13 cancels the change of the data models in the data model storage unit 6 and maintains the original data models.

Upon receiving the notification of the block information correction contents and the generation rule correction instruction from the block information correction unit 12, the generation rule correction unit 14 inputs the change contents of generation rules so as to reflect the correction contents of the block information in accordance with the instruction. In addition, the generation rule correction unit 14 inputs the change contents of the generation rules in accordance with the user's desire. The change contents of the generation rules are temporarily stored in, e.g., the generation rule storage unit 8.

The generation rule correction unit 14 notifies the consistency verification unit 15 of the change contents of the generation rules to instruct it to determine whether the change contents are consistent with the data models and text. When the determination result returned from the consistency verification unit 15 indicates that the change contents are consistent, the generation rule correction unit 14 changes the generation rules in the generation rule storage unit 8 in accordance with the change contents. When the determination result indicates that the change contents are not consistent, the generation rule correction unit 14 cancels the change of the generation rules in the generation rule storage unit 8.

When the change contents received from the data model correction unit 13 or generation rule correction unit 14 are applied, the consistency verification unit 15 determines whether the text, data models, and generation rules are consistent with each other and returns the determination result. Whether they are consistent is determined by determining whether the text, data models, and generation rules have no contradiction.

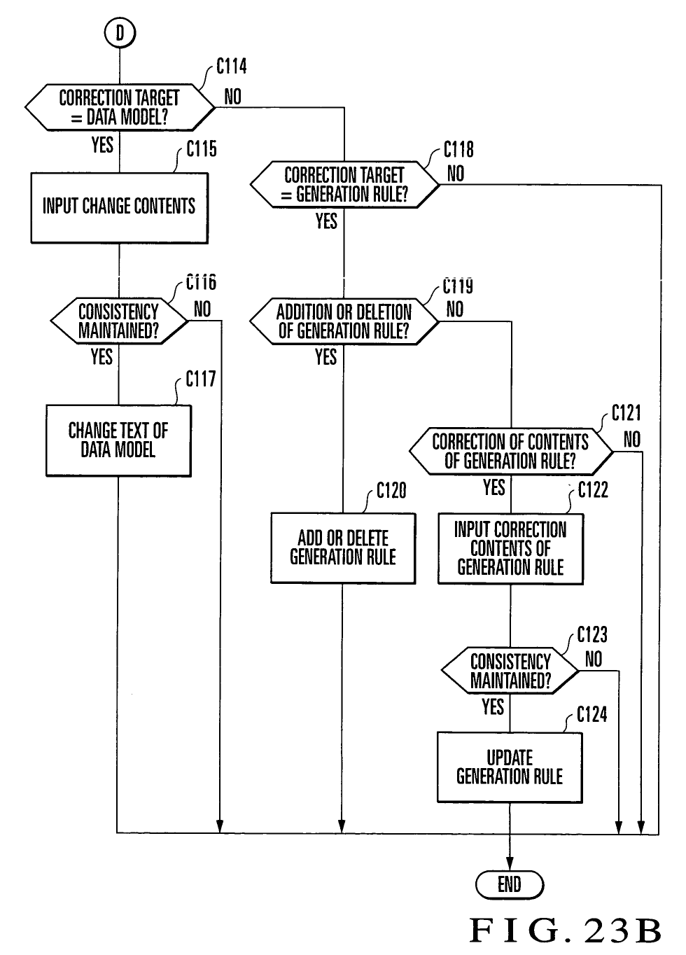

FIGS. 23A and 23B show the operation of the third embodiment. Referring to FIG. 23A, first, the template creation apparatus determines whether the correction target is a text (step C101). If the correction target is a text, the text correction unit 11 selects a block which encloses the character string to be corrected from the pieces of block information of all layers in the text (step C102). The text correction unit 11 determines whether the selected block is a delimiter block (step C103).

If the selected block is a delimiter block, the text correction unit 11 corrects the character string of the delimiter block (step C104). If the selected block is no delimiter block, the text correction unit 11 changes the character string of the selected block (step C105). After the processing in step C104 or C105, in accordance with an instruction from the text correction unit 11, the block information correction unit 12 corrects (shifts) the range of the block which is shifted by changing the character string (step C106). In accordance with an instruction from the text correction unit 11, the data model correction unit 13 updates the character string of the data model corresponding to the changed block (step C107), and the processing is ended.

If it is determined in step C101 that the correction target is no text, the template creation apparatus determines whether the correction target is block information (step C108). If the correction target is block information, the block information correction unit 12 determines whether to change the range of a block by correction (step C109). If the range of a block is to be changed by correction, the block information correction unit 12 changes the range of a block in accordance with it (step C110). The data model correction unit 13 updates the character string of the data model corresponding to the changed block in accordance with an instruction from the block information correction unit 12 (step C111).

If it is determined in step C109 that no block range is to be changed by correction, the block information correction unit 12 determines whether to add or delete a block by correction (step C112). If a block is to be added or deleted by correction, the block information correction unit 12 adds or deletes a block. After that, the generation rule correction unit 14 adds or deletes the generation rule corresponding to the block (step C113), and the processing is ended. If it is determined in step C112 that no block is to be added or deleted by correction, the processing is ended without changing the generation rule.

If it is determined in step C108 that the correction target is no block information, the template creation apparatus determines whether the correction target is a data model, as shown in FIG. 23B (step C114). If the correction target is a data model, the data model correction unit 13 inputs the change contents of a data model (step C115). The consistency verification unit 15 determines whether the change contents can maintain the consistency between the data model, generation rule, and text (step C116). If the change contents can maintain the consistency, the data model correction unit 13 changes the data model in accordance with the change contents (step C117). If the correction contents cannot maintain the consistency, the data model correction unit 13 cancels the change, and the processing is ended.

If it is determined in step C114 that the correction target is no data model, the template creation apparatus determines whether the correction target is a generation rule (step C118). If the correction target is a generation rule, the generation rule correction unit 14 determines whether to add or delete a generation rule by correction (step C119). If a generation rule is to be added or deleted by correction, the generation rule correction unit 14 adds or deletes a generation rule (step C120).

If it is determined in step C119 that no generation rule is to be added or deleted by correction, the generation rule correction unit 14 determines whether to change the contents of a generation rule by correction (step C121). If the contents of a generation rule are to be changed by correction, the generation rule correction unit 14 inputs the change contents of the generation rule in accordance with it (step C122). The consistency verification unit 15 determines whether the change contents can maintain the consistency between the data model, generation rule, and text (step C123). If the change contents can maintain the consistency, the generation rule correction unit 14 changes the generation rule in accordance with the change contents (step C124). If the correction contents cannot maintain the consistency, the generation rule correction unit 14 cancels the change, and the processing is ended.

According to the template creation apparatus according to the above-described third embodiment, the contents of cases can be changed by the text correction unit 11, block information correction unit 12, data model correction unit 13, and generation rule correction unit 14. When the data model correction unit 13 or generation rule correction unit 14 inputs change contents, the consistency verification unit 15 determines whether the change contents can maintain the consistency between the data model, block information, and text. Only when the consistency can be maintained, the data model correction unit 13 or generation rule correction unit 14 executes change. For this reason, even when the contents of a case are changed, the specifications can appropriately be corrected without any contradiction between the pieces of information.

The template creation apparatus according to the above-described present invention is operated by a computer controlled by a program. The program sends instructions to the respective constituent elements of the computer and causes them to execute predetermined processing necessary for the operation of, e.g., a support center. As described above, the processing and operations of the present invention can be implemented by a specific means by cooperation of the program and computer.

The program is stored in a recording medium such as a ROM (Read Only Memory) or RAM (Random Access Memory). The program is read from the recording medium mounted in the computer into the computer and executed.

For example, the program can also be read into the computer through a communication line. The recording medium to store the program can include by, e.g., a semiconductor memory, magnetic disk, optical disk, or any other arbitrary recording means readable by an arbitrary computer.

The present invention can be used to, e.g., create a template to be used in a template engine in generating a source code from a software model of UML (Unified Modeling Language) limited to the notation.

The present invention can also be used to create a template to be used to generate a Web page.

As described above, according to the present invention, the specifications of a complex template can easily be defined by using a sample text whose contents are easy to grasp, and block information, data models, and generation rules related to the text.

The specifications of the template can be reviewed by checking the block information, data models, and generation rules for the sample text. Hence, the specifications of the template can easily be reviewed without any necessity to directly check the complex template.

The template creation apparatus mechanically creates a template in accordance with given specifications without causing a user to directly edit the template. No syntax errors can occur in the template. In addition, debug can be executed only by editing the sample text, block information, data models, or generation rules without generating any text by using the template. A measure against a compile error can easily be taken, and debug can efficiently be executed.

Since the specifications of the template are given by cases, no alienation between the requested specifications and the actually created template occurs in principle. It is only necessary to verify whether the specifications themselves are plausible. Since the coincidence between the specifications and the template need not be verified, the test of the template can efficiently be done.

Since the generalization means generalizes data models and generation rules by merging overlapping data models, the redundancy of the template created from these pieces of information is reduced.

Since the generalization means removes the overlap in the if-then-else syntax in the template generated by the template generation means, the redundancy of the template is reduced.

When the data model correction means or generation rule correction means inputs change contents, the consistency verification means determines whether the change contents can maintain the consistency between the data model, block information, and text. Only when the consistency can be maintained, the data model correction means or generation rule correction means executes change. For this reason, even when the contents of a case are changed, the specifications can appropriately be corrected without any contradiction between the pieces of information.

1. A template creation apparatus which creates a template to be used as a model in generating a text containing a character string, comprising:
text input means for inputting at least one sample text serving as a sample of the text which can be generated by using the template;
block information input means for inputting, in correspondence with the sample text input by said text input means, block information representing a range and structure of an insertion block in which a character string can be replaced in the template;
data model input means for inputting a data model serving as a base of the character string of the insertion block in the sample text input by said text input means;
generation rule input means for inputting a generation rule to generate the character string of the insertion block in the sample text from the data model input by said data model input means; and
template generation means for generating the template by making the range of the insertion block in the sample text input by said text input means replaceable and inserting the character string generated on the basis of the generation rule in the replaceable insertion block.

2. An apparatus according to claim 1, wherein
said block information input means hierarchically sets another insertion block in the insertion block,
said generation rule input means inputs a generation rule of the insertion block which is hierarchically set in the insertion block, and
said template generation means generates the template in which the insertion block is hierarchically set by making the range of the insertion block of each layer in the sample text replaceable and inserting the character string generated on the basis of the generation rule in the replaceable insertion block.

3. An apparatus according to claim 1, wherein
said block information input means sets a repetitive structure having a plurality of element blocks in the insertion block in accordance with a structure of the text,
said generation rule input means inputs the generation rule of the insertion block and simultaneously a generation rule of each element block in the corresponding insertion block, and
said template generation means generates the template by making the range of the insertion block in the sample text input by said text input means replaceable, and when character strings of the element blocks in the insertion block, which are generated on the basis of the generation rule, are common, inserting a character string representing the character strings of the element blocks in the insertion block, and when the character strings of the element blocks in the insertion block are not common, inserting, in the insertion block, a character string obtained by connecting the character strings of the element blocks by an if-then-else syntax.

4. An apparatus according to claim 1, wherein
said text input means inputs a plurality of sample texts serving as the sample of the text which can be generated by using the template,
said block information input means inputs, in correspondence with each of the sample texts input by said text input means, the block information representing the range and structure of the insertion block in which the character string can be replaced in the template,
said generation rule input means inputs, for each sample text, the generation rule to generate the character string of the insertion block in the sample text input by said text input means from the data model input by said data model input means, and
said template generation means generates the template by making the range of the insertion block replaceable and when character strings of the samples generated by the generation rule and related to the same insertion block are common, inserting a character string representing the character strings of the samples in the insertion block, and when the character strings of the samples related to the same insertion block are not common, inserting, in the insertion block, a character string obtained by connecting the character strings of the samples by an if-then-else syntax.

5. An apparatus according to claim 1, wherein when common insertion blocks are present in the created template, said template generation means simplifies the template by inserting a character string representing the common insertion blocks in a corresponding insertion block.

6. An apparatus according to claim 1, further comprising generalization means for detecting common data models between the sample texts, between the insertion blocks, and between the element blocks and replacing character strings of the common data models with a data model having a representative character string.

7. An apparatus according to claim 6, wherein when the template generated by said template generation means has an if-then-else syntax portion, and character strings connected by the if-then-else syntax include a plurality of character strings common to each other, said generalization means replaces the plurality of character strings with a character string representing the plurality of character strings.

8. An apparatus according to claim 1, further comprising
consistency verification means for verifying whether the sample text, data model, and generation rule are consistent to each other,
data model correction means for, when change of the data model is requested, determining change contents and instructing said consistency verification means to verify whether the sample text, data model, and generation rule are consistent to each other, when consistency is ensured, changing the data model in accordance with the determined change contents, and when no consistency is ensured, canceling the change of the data model, and
generation rule correction means for, when change of the generation rule is requested, determining change contents and instructing said consistency verification means to verify whether the sample text, data model, and generation rule are consistent to each other, when consistency is ensured, changing the generation rule in accordance with the determined change contents, and when no consistency is ensured, canceling the change of the generation rule.

9. An apparatus according to claim 8, further comprising
text correction means for changing the sample text input by said text input means at user's discretion, and
block information correction means for changing the block information in accordance with change contents when said text correction means changes the sample text and changing the block information input by said block information input means at user's discretion,
wherein when said text correction means changes the text, said data model correction means changes the data model in accordance with the change contents, and when said block information correction means changes the block information, said data model correction means changes the data model at user's discretion, and
when said block information correction means changes the block information, said generation rule correction means executes one of change of the generation rule in accordance with the change contents and change of the generation rule at user's discretion.

10. A template creation method of causing a computer to create a template to be used as a model in generating a text containing a character string, comprising:
the first step of inputting at least one sample text serving as a sample of the text which can be generated by using the template;
the second step of inputting, in correspondence with the input sample text, block information representing a range and structure of an insertion block in which a character string can be replaced in the template;
the third step of inputting a data model serving as a base of the character string of the insertion block in the input sample text;
the fourth step of inputting a generation rule to generate the character string of the insertion block in the sample text from the input data model; and
the fifth step of generating the template by making the range of the insertion block in the input sample text replaceable and inserting the character string generated on the basis of the generation rule in the replaceable insertion block.

11. A method according to claim 10, wherein
the second step comprises the step of hierarchically setting another insertion block in the insertion block,
the fourth step comprises the step of inputting a generation rule of the insertion block which is hierarchically set in the insertion block, and
the fifth step comprises the step of generating the template in which the insertion block is hierarchically set by making the range of the insertion block of each layer in the input sample text replaceable and inserting the character string generated on the basis of the generation rule in the replaceable insertion block.

12. A method according to claim 10, wherein
the second step comprises the step of setting a repetitive structure having a plurality of element blocks in the insertion block in accordance with a structure of the text,
the fourth step comprises the step of inputting the generation rule of the insertion block and simultaneously a generation rule of each element block in the corresponding insertion block, and
the fifth step comprises the step of generating the template by making the range of the insertion block in the input sample text replaceable, and when character strings of the element blocks in the insertion block, which are generated on the basis of the generation rule, are common, inserting a character string representing the character strings of the element blocks in the insertion block, and when the character strings of the element blocks in the insertion block are not common, inserting, in the insertion block, a character string obtained by connecting the character strings of the element blocks by an if-then-else syntax.

13. A method according to claim 10, wherein
the first step comprises the step of inputting a plurality of sample texts serving as the sample of the text which can be generated by using the template,
the second step comprises the step of inputting, in correspondence with each of the input sample texts, the block information representing the range and structure of the insertion block in which the character string can be replaced in the template,
the fourth step comprises the step of inputting, for each sample text, the generation rule to generate the character string of the insertion block in the input sample text from the input data model, and
the fifth step comprises the step of generating the template by making the range of the insertion block replaceable, and when character strings of the samples generated by the generation rule and related to the same insertion block are common, inserting a character string representing the character strings of the samples in the insertion block, and when the character strings of the samples related to the same insertion block are not common, inserting, in the insertion block, a character string obtained by connecting the character strings of the samples by an if-then-else syntax.

14. A method according to claim 10, wherein the fifth step comprises the step of, when common insertion blocks are present in the created template, simplifying the template by inserting a character string representing the common insertion blocks in a corresponding insertion block.

15. A method according to claim 10, further comprising the sixth step of detecting common data models between the sample texts, between the insertion blocks, and between the element blocks and replacing character strings of the common data models with a data model having a representative character string.

16. A method according to claim 15, wherein the sixth step comprises the step of, when the created template has an if-then-else syntax portion, and character strings connected by the if-then-else syntax include a plurality of character strings common to each other, replacing the plurality of character strings with a character string representing the plurality of character strings.

17. A method according to claim 10, further comprising
the seventh step of verifying whether the sample text, data model, and generation rule are consistent to each other,
the eighth step of, when change of the data model is requested, instructing to verify whether change contents can ensure consistency between the sample text, data model, and generation rule, when consistency is ensured, changing the data model in accordance with the change contents, and when no consistency is ensured, canceling the change of the data model, and
the ninth step of, when change of the generation rule is requested, instructing to verify whether determined change contents can ensure consistency between the sample text, data model, and generation rule, when consistency is ensured, changing the generation rule in accordance with the determined change contents, and when no consistency is ensured, canceling the change of the generation rule.

18. A method according to claim 17, further comprising
the 10th step of changing the input sample text at user's discretion,
the 11th step of, when the input sample text is changed, changing the block information in accordance with change contents, and
the 12th step of changing the input block information at user's discretion,
wherein the third step comprises the step of, when the text is changed, changing the data model in accordance with the change contents, and a step of, when the block information is changed, changing the data model at user's discretion, and
the fourth step comprises the step of, when the block information is changed in accordance with the change contents, changing the generation rule in accordance with change contents, and a step of, when the block information is changed at user's discretion, changing the generation rule at user's discretion.

19. A recording medium which records a template creation program to create a template to be used as a model in causing a computer to generate a text containing a character string,
the template creation program comprising a program which executes
a procedure for inputting a sample text serving as a sample of the text which can be generated by using the template;
a procedure for inputting, in correspondence with the input sample text, block information representing a range and structure of an insertion block in which a character string can be replaced in the template;
a procedure for inputting a data model serving as a base of the character string of the insertion block in the input sample text;
a procedure for inputting a generation rule to generate the character string of the insertion block in the sample text from the input data model; and
a procedure for generating the template by making the range of the insertion block in the input sample text replaceable and inserting the character string generated on the basis of the generation rule in the replaceable insertion block.
